(19) United States
(12) Patent Application Publication
(10) Pub. No.: US 2021/0092007 A1
(43) Pub. Date: Mar. 25, 2021

(54) SYSTEMS AND METHODS OF PROGRESSIVE CLOUD BASED ARCHITECTURE

(71) Applicant: Schneider Electric USA, Inc., Andover, MA (US)

(72) Inventors: Victor DANILCHENKO, Andover, MA (US); Thomas WHITEHILL, Andover, MA (US)

(21) Appl. No.: 17/040,285

(22) PCT Filed: Mar. 25, 2019
(86) PCT No.: PCT/US19/23879

§ 371 Date: Sep. 22, 2020

Related U.S. Application Data
(60) Provisional application No. 62/647,062, filed on Mar. 23, 2018.

(51) Int. Cl. H04L 12/24

(52) U.S. Cl. CPC H04L 41/082

(57) ABSTRACT

Systems and methods for a progressive network connectivity architecture allow companies to selectively enable and disable network or cloud-based services according to customer and/or internal requirements. Depending on the application and/or environment, connected elements may be progressively connected to the cloud to facilitate sensing, actuation, data capture, data storage, or data processing in increasing or decreasing connected environments. Each connected element may be operated or utilized progressively in various connected environments, from completely isolated to completely connected.

### CROSS-REFERENCE TO RELATED APPLICATIONS

This application for patent claims the benefit of priority to and hereby incorporates by reference U.S. Provisional Application No. 62/647,062, entitled “Systems and Methods of Progressive Cloud Based Architecture,” filed Mar. 23, 2018.

### FIELD OF THE INVENTION

Embodiments of the present disclosure relate generally to system architectures for making use of network-based and cloud-based services and more specifically to systems and methods for implementing a flexible cloud-based or network-based architecture that allows for progressive connectivity to a network, such as the cloud.

### BACKGROUND

The “cloud” or “cloud computing” as used herein generally refers to a network of computers and servers, both physical and virtual, that provide data storage, processing, and other computing services over a network connection instead of locally. Connecting to the network or cloud allows systems, subsystems, devices, and many other connected elements to interconnect, interact, and share data in a connected environment that, if done over the Internet, is often referred to as the Internet of Things (IoT). The services provided via the cloud may include, for example, data storage, data processing, data analytics, event monitoring and detection, alarm notification, user authentication/authorization, data integration, and the like. Some of these cloud-based services are often referred to by what they provide “as a service,” such as Software as a Service (SaaS), Data Storage as a Service (DaaS), Infrastructure as a Service (IaaS), Platform as a Service (PaaS), among others. The number and type of cloud-based services provided are typically specified in service level agreements (SLA) with the services providers.

Current system architectures, however, do not permit configuration or reconfiguration of connected devices for receiving different levels or tiers of network-based services from their existing services. A progressive cloud-based or network-based architecture that allows companies to selectively enable and disable network-based services according to customer and/or internal requirements addresses this need.

### SUMMARY OF THE DISCLOSED EMBODIMENTS

Embodiment disclosed herein provide a progressive network-based architecture that allows companies to selectively enable and disable network-based or cloud-based services according to customer and/or internal requirements. Depending on the application and/or environment, connected elements may be progressively connected to the cloud to facilitate sensing, actuation, data capture, data storage, or data processing in increasing or decreasing connected environments. Each connected element may be operated or utilized progressively in various connected environments, from completely isolated to completely connected, as alluded to earlier.

The embodiments disclosed herein are particular useful in the emerging world of the Internet of Things (IoT) or more generally, Cyber Physical Systems (CPS), where a convergence of multiple technologies is underway to allow the sensing, actuation, data capture, storage, or processing from a large array of connected elements. These connected elements may be accessed remotely using existing network connectivity infrastructure to allow for efficient Machine to Machine (M2M) and Human to Machine (H2M) communication. Embodiments disclosed herein address the foregoing issues with a system architecture permitting a scalable approach to allow one or more connected elements to move toward level of connectivity to allow expanding or contracting capabilities for security of devices, scalability of access, and/or safety of users.

It should be appreciated that elements of a progressive connectivity approach as disclosed herein may be utilized for non-IoT architectural solutions as well as IoT architectural solutions. As one example, a service-oriented architecture may also be structured in a progressive manner, allowing scaling of connectivity from strictly local to cloud-capable.

Some embodiments disclosed herein provide systems and methods for implementing a progressive network connectivity architecture that allows products and applications to be selectively configured for cloud access. With such an architecture, applications which are non-cloud-enabled and/or companies that are reluctant to embrace a fully connected environment may move toward cloud access gradually. This may be accomplished by utilizing and integrating the capabilities of the connected environment in an incremental manner, while receiving added business value at each step of the process.

A user or an administrator system may manually or automatically control the configuration of various aspects of an application, which may pertain to choosing local or cloud functionality for the application, for example. This allows a user or an admin system to manually or autonomously select the degree of cloud connectivity appropriate for their requirements or restrictions. Such an architecture further allows a user or admin system to adjust these configuration options over time.

One embodiment of a progressive network connectivity architecture may structure the functional capabilities of an application to allow functionality both in non-cloud-enabled and cloud-enabled environments. It should be appreciated that a non-cloud-enabled environment may nevertheless provide shared computing capabilities, which may resemble a “cloud” environment, but such shared computing capabilities may be available in a local computing environment only. In contrast, a cloud-enabled-environment provides shared computing capabilities that are available on a wider or even global scale. In both cases, each set of computing capabilities provides unique characteristics and value to the operators of the devices in the local computing environment.

Some users (e.g., oil refineries) may be reluctant to embrace the cloud for reasons of security and safety concerns, among others. Such concerns may be due to the magnitude of damage an accident or a security breach may cause, such as large-scale environmental damage due to a refinery accident, or lost lives due to power grid security compromise. Customers or autonomous systems can restrict or decrease levels of connectivity if certain scenarios arise, such as a cyber-attack or threat.

The disclosed progressive network connectivity architecture structures functional product component profiles in a manner which supports scalability across a connectivity spectrum, from fully disconnected to partially connected to fully cloud connected and enabled. A user or an administrator system can configure the architecture in such a manner which permits the application to function with a progressive trade-off of connected functionality and risk. Adjustments may be made as a result of an event, stored profile, and/or prospectively in an automated fashion as a result of other analysis conducted through external data sources, such as weather data.

A progressive network connectivity architecture may allow adjustments to be applied as configurations. In one aspect, controlling the behavior of a number of application characteristics simultaneously in a granular manner in response to a specific context, and in accordance with the organization policies. It should be appreciated these examples are not exhaustive as to the type and number of solutions that are possible with such a progressive network connectivity architecture.

The progressive network connectivity architecture allows users to configure an application to exercise features and behaviors they are comfortable with and which are permitted by their policies. Then, the system allows them to update the configuration and enable or disable additional behaviors to align with current needs. Features and behaviors can be reconfigured by the users to respect their internal rules and policies, and may be updated in near real time as those rules and policies change.

A company may comply with varying regulatory markets, where the progressively architected application may be structured so as to respect specific regulations on a per-policy basis. By applying various configuration policies for the application instances in various markets (e.g., Europe, USA, China, Saudi Arabia), the system allows the company to distribute the same product across the world, delivering maximum legally permissible feature sets in each market, yet still complying with the complex variety of regulatory requirements.

In the event a digital security threat is detected at a given site or another connected site, a policy disabling particular types of activities (e.g., cross-site integration if there is a breach at another connected site), and/or identity federation (if the identity provider is being attacked) may be implemented. Such a policy may be also applied using a variety of characteristics, such as, for example, intrusion detection services or trusted third-party reports.

Progressively architected application policies may be structured so as to implement subscription levels as progressivity configurations. The system architecture allows the application to be reconfigured to enable or disable additional functionality if a customer changes their subscription level.

Organizations may apply additional configurations to a progressive architecture under various situations. For example, a customer may apply a configuration due to a security policy (in the event of a security threat), but a vendor may apply a configuration due to licensing policy (in the event of a subscription level change).

With a progressive architecture, companies have the option of choosing the connected level of their environment on a connectivity spectrum from disconnected to fully connected on a device by device, configuration by configuration, and/or system by system level

For example, a refinery plant may be tremendously security-conscious due to the potential damage of an operational incident. A progressive network connectivity architecture may make it possible to allow such a refinery plant to start out in a completely disconnected configuration, then progressively enable cloud-based features as the plant becomes comfortable with them and explore their implications.

A customer application may have other requirements about which data types and entities may be stored and what level of connectivity is acceptable. Migrating such data types and entities to a more connected platform will allow the cloud functional components to access and utilize them. Such configuration may allow the application to achieve progressive functionality spanning the complete range from local to cloud.

Thus, in general, in one aspect, one or more embodiments of the present disclosure are directed to a system for progressively enabling or disabling network-based services provided to a plurality of subsystems. The system comprises a configuration store having a plurality of configuration records therein, wherein one or more configuration records correspond to a subsystem and includes a configuration state for the subsystem, and wherein one or more configuration states specify which network-based services may be provided to the subsystem. The system further comprises a configuration processor coupled to communicate with the configuration store, the configuration processor operable to update the configuration records in the configuration store to include updated configuration states and to distribute the updated configuration states to the subsystem for processing by a configuration connector in the subsystem, the configuration connector operable to identify one or more configuration actions that need to be performed to modify a configuration of the subsystem based on an updated configuration state for the subsystem. The subsystem is provided with network-based services as specified by an updated configuration state for the subsystem and the configuration of the subsystem is modified to support the network-based services as specified by the updated configuration state for the subsystem.

In general, in another aspect, one or more embodiments of the present disclosure are directed to a non-transitory computer-readable medium storing computer-readable instructions for causing a computing system to progressively enable or disable network-based services provided to a plurality of subsystems. The computer-readable instructions comprising instructions that cause the computer to store a plurality of configuration records in a configuration store, wherein one or more configuration records correspond to a subsystem and includes a configuration state for the subsystem, and wherein one or more configuration states specify which network-based services may be provided to the subsystem. The computer-readable instructions further comprising instructions that cause the computer to update the configuration records in the configuration store to include updated configuration states and distribute the updated configuration states to the subsystem for processing by a configuration connector in the subsystem, the configuration connector operable to identify one or more configuration actions that need to be performed to modify a configuration of the subsystem based on an updated configuration state for the subsystem. The subsystem is provided with network-based services as specified by an updated configuration state for the subsystem and the configuration of the subsystem is modified to support the network-based services as specified by the updated configuration state for the subsystem.

In general, in yet another aspect, one or more embodiments of the present disclosure are directed to a method of progressively enabling or disabling network-based services provided to a plurality of subsystems. The method comprises storing a plurality of configuration records in a configuration store, wherein one or more configuration records correspond to a subsystem and include a configuration state for the subsystem, and wherein one or more configuration states specify which network-based services may be provided to the subsystem. The method further comprises updating the configuration records in the configuration store to include updated configuration states and distributing the updated configuration states to the subsystem for processing by a configuration connector in the subsystem, the configuration connector operable to identify one or more configuration actions that need to be performed to modify a configuration of the subsystem based on an updated configuration state for the subsystem. The subsystem is provided with network-based services as specified by an updated configuration state for the subsystem and wherein the configuration of the subsystem is modified to support the network-based services as specified by the updated configuration state for the subsystem.

In general, in still another aspect, one or more embodiments of the present disclosure are directed to a system for progressively enabling or disabling network-based services provided to a plurality of subsystems. The system comprises a configuration store having a plurality of configuration records therein, wherein one or more configuration records correspond to a subsystem and includes a configuration state for the subsystem, and wherein one or more configuration states specifies specify which network-based services may be provided to the subsystem. The system further comprises a configuration processor coupled to communicate with the configuration store, the configuration processor operable to update the configuration records in the configuration store to include updated configuration states. The subsystem is provided with network-based services as specified by an updated configuration state for the subsystem and the configuration of the subsystem is modified to support the network-based services as specified by the updated configuration state for the subsystem.

In general, in yet another aspect, one or more embodiments of the present disclosure are directed to a non-transitory computer-readable medium storing computer-readable instructions for causing a computing system to progressively enable or disable network-based services provided to a plurality of subsystems. The computer-readable instructions comprising instructions that cause the computer to store a plurality of configuration records in a configuration store, wherein one or more configuration records correspond to a subsystem and includes a configuration state for the subsystem, and wherein one or more configuration states specifies specify which network-based services may be provided to the subsystem. The computer-readable instructions further comprising instructions that cause the computer to update the configuration records in the configuration store to include updated configuration states. The subsystem is provided with network-based services as specified by an updated configuration state for the subsystem and the configuration of the subsystem is modified to support the network-based services as specified by the updated configuration state for the subsystem.

In general, in yet another aspect, one or more embodiments of the present disclosure are directed to a method of progressively enabling or disabling network-based services provided to a plurality of subsystems. The method comprises storing a plurality of configuration records in a configuration store, wherein one or more configuration records correspond to a subsystem and include a configuration state for the subsystem, and wherein one or more configuration states specify which network-based services may be provided to the subsystem. The method further comprises updating the configuration records in the configuration store to include updated configuration states. The subsystem is provided with network-based services as specified by an updated configuration state for the subsystem and wherein the configuration of the subsystem is modified to support the network-based services as specified by the updated configuration state for the subsystem.

### BRIEF DESCRIPTION OF THE DRAWINGS

The foregoing and other advantages of the disclosed embodiments will become apparent upon reading the following detailed description and upon reference to the drawings, wherein:

FIGS. 1A-1B illustrate an exemplary application that may use a progressive network connectivity architecture according to embodiments of this disclosure;

FIG. 2 illustrates exemplary devices for a progressive network connectivity architecture according to embodiments of this disclosure;

FIG. 3 illustrates an exemplary deployment of various connected elements of a progressive network connectivity architecture according to embodiments of this disclosure;

FIG. 4 illustrates an exemplary progressive network connectivity architecture according to embodiments of this disclosure;

FIG. 5 illustrates an exemplary implementation of a progressive network connectivity architecture according to embodiments of this disclosure;

FIG. 6 illustrates an exemplary implementation of some of the components of a progressive network connectivity architecture according to embodiments of this disclosure;

FIG. 7 illustrates an exemplary implementation of another component of a progressive network connectivity architecture according to embodiments of this disclosure;

FIGS. 8A-8B illustrate exemplary configuration update sequences for a progressive network connectivity architecture according to embodiments of this disclosure;

FIG. 9 illustrates an exemplary implementation of a real-time data processing subsystem according to embodiments of this disclosure;

FIGS. 10A-10B illustrate exemplary real-time data processing sequences according to embodiments of this disclosure;

FIG. 11 illustrates an exemplary implementation of a data visualization subsystem according to embodiments of this disclosure;

FIG. 12 illustrates an exemplary implementation of a cross-site integration subsystem according to embodiments of this disclosure;

FIG. 13 illustrates an exemplary implementation of an authentication and authorization subsystem according to embodiments of this disclosure;

FIGS. 14A-14B illustrate exemplary authentication and authorization sequences according to embodiments of this disclosure;

FIG. 15 illustrates an exemplary implementation of a data segregation subsystem according to embodiments of this disclosure;

FIGS. 16A-16D illustrate exemplary responses to a security breach in a progressive network connectivity architecture according to embodiments of this disclosure;

FIGS. 17A-17D illustrate exemplary regulatory compliance in a progressive network connectivity architecture according to embodiments of this disclosure;

FIG. 18 illustrates an exemplary computing system that may be used to implement various embodiments of this disclosure; and

FIG. 19 illustrates an exemplary storage system that may be used to implement various embodiments of this disclosure.

### DETAILED DESCRIPTION OF THE DISCLOSED EMBODIMENTS

As an initial matter, it will be appreciated that the development of an actual, real commercial application incorporating aspects of the disclosed embodiments will require many implementation specific decisions to achieve a commercial embodiment. Such implementation specific decisions may include, and likely are not limited to, compliance with system related, business related, government related and other constraints, which may vary by specific implementation, location and from time to time. While a developer's efforts might be considered complex and time consuming, such efforts would nevertheless be a routine undertaking for those of skill in this art having the benefit of this disclosure.

It should also be understood that the embodiments disclosed and taught herein are susceptible to numerous and various modifications and alternative forms. Thus, the use of a singular term, such as, but not limited to, “a” and the like, is not intended as limiting of the number of items. Similarly, any relational terms, such as, but not limited to, “top,” “bottom,” “left,” “right,” “upper,” “lower,” “down,” “up,” “side,” and the like, used in the written description are for clarity in specific reference to the drawings and are not intended to limit the scope of the invention.

This disclosure is not limited in its application to the details of construction and the arrangement of components set forth in the following descriptions or illustrated by the drawings. The disclosure is capable of other embodiments and of being practiced or of being carried out in various ways. Also, the phraseology and terminology used herein is for the purpose of descriptions and should not be regarded as limiting. The use of “including,” “comprising,” “having,” “containing,” “involving,” and variations herein, are meant to be open-ended, i.e., “including but not limited to.”

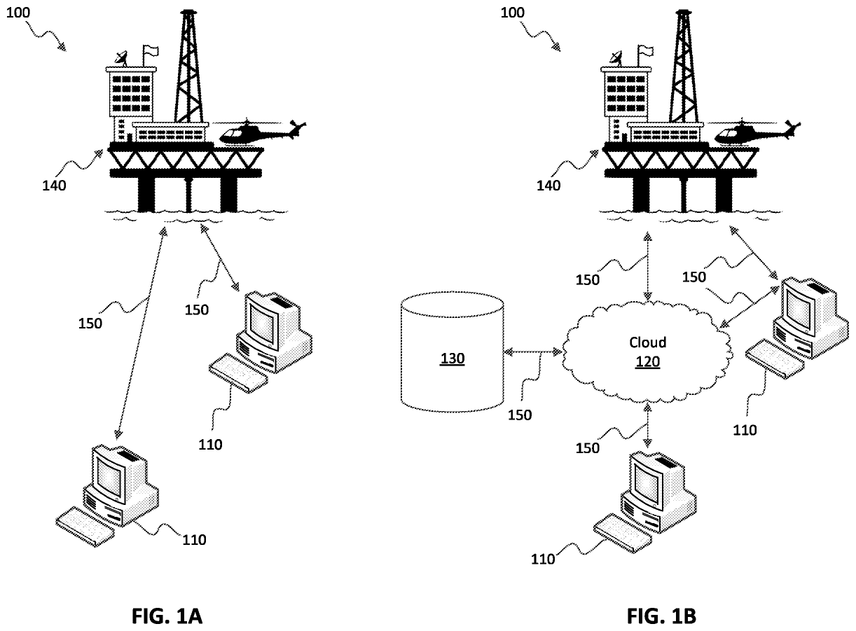

Referring now to FIGS. 1A-1B, an application is shown in which an exemplary progressive connectivity architecture 100 for a network may be used according to various embodiments of the present disclosure. This progressive network-based or cloud-based architecture 100 generally includes one or more connected elements 110, such as one or more computing devices or services, that may be connected to other connected elements and components of a building or structure 140, as shown in FIG. 1A. The one or more connected elements 110 may also be connected to a network 120, which may be a cloud computing environment or “cloud” 120 in some embodiments, having one or more data storage devices 130, as shown in FIG. 1B. Network connections 150 allow these various connected elements 110 and components of the structure 140 to be coupled to communicate with each other and with the cloud 120 and the data storage devices 130 as well as other cloud-based functionality.

In the present example, the application is an offshore drilling application and the structure 140 represents an offshore drilling rig of the type often used to drill a well into a subsea formation. Such a structure 140 typically has numerous connected elements 110 that perform a variety of functions, such as sensing, actuation, data capture, data storage, and data processing for monitoring or managing the structure 140. One or more of these connected elements 110 may be initially confined to the structure 140 only, as shown in FIG. 1A, or one or more of these connected elements 110 may be connected both locally and to the cloud 120, as shown in FIG. 1B.

In accordance with the disclosed embodiments, the progressive network connectivity architecture 100 allows the connected elements 110 of the structure 140 to be systematically configured/reconfigured for local-only connection or for local-plus-cloud connection as needed. Thus, for example, connected elements 110 that are connected only locally at the structure 140 can be selectively configured/reconfigured to connect to the cloud 120, and vice versa, or both. The configuring and reconfiguring may be implemented automatically to all of the connected elements 110 at once or to only some of the connected elements 110 as needed. Such an architecture 100 lets an operator of the structure 140 or admin personnel or automated monitoring system quickly and easily enable and disable cloud-based services as needed for the connected elements 110 of the structure 140 according to customer and/or internal requirements without having to make changes on an individual element basis.

Any variety of connected elements 110 may be used, including physical elements (e.g., devices, sensors, etc.) as well as virtual elements (e.g., analytics, authentication, etc.) that capture, store, and process data, or actuate associated devices over the network connections 150, whether entirely locally relative to the structure 140 or to a connected environment like the cloud 120. These connected elements may, for example, detect temperature, humidity, ambient light, sound, smoke, carbon monoxide, carbon dioxide, motion, pressure, non-conductive fluids, conductive fluids, vibration, energy, power, voltage, current, rotation speed (RPM), rate of penetration (ROP), weight on bit (WOB), and many other desired characteristics, and combinations thereof. Connected elements may also operate or articulate elements, components, and/or other systems such as turning on lights, opening a door or window, moving window shades, triggering a door lock, controlling a drive, initiating a process, or communicating with a PLC. Connected elements may also process data structures from other connected elements or propagate data structures from one or more connected elements to one or more other connected elements. The connected elements may be physical elements, such as actuators, sensors, and the like, or they may be virtual elements, as in the case of a cloud-based solution that may have no physical sensors or actuators. Any number of connected elements may be deployed in any combination to monitor connected systems or manage an area or space. Examples of the latter may include a closet, room, building, campus, office, promenade, rig floor, or any other desired location.

Similarly, each structure containing a connected element like the structure 140 may ultimately connect to the cloud-computing environment 120 through the network connections 150. This allows access to the cloud computing environment 120 by a variety of devices capable of connecting to such an environment in either a wired or wireless connection manner. Such devices may include one or more general-purpose computers 110 capable of receiving input from a user or providing autonomous operation. Additionally, the one or more data storage arrays 130 may be utilized to provide additional data storage capability. It should be appreciated a cloud computing environment 120, while providing additional communication paths to additional elements or systems, is not required as part of the disclosed progressive network connectivity architecture. Some embodiments contemplate self-contained or stand-alone networks where network-based computing and data storage services are provided only to the connected elements 110 of the structure 140 by other connected elements of the structure 140. Thus, although the term “cloud” or “cloud-based” may be used in some instances, it is to be understood throughout this description that the progressive connectivity architecture herein may be implemented on any network or computing environment where computing resources are shared (i.e., a shared computing environment).

The network connections 150 may be wired or wireless connection types. Such connections may include, but are not limited to, any physical cabling method such as category 5 cable, coaxial, fiber, copper, twisted pair, or any other physical media to propagate electrical signals. Wireless connections may include, but are not limited to personal area networks (PAN), local area networks (LAN), low-power networks (LPWAN), Wi-Fi, Bluetooth, cellular, global, or space-based communication networks. Access between the network or cloud environment 120 and any other network or cloud environment is possible in implementations where these other network or cloud environments are configured to connect with devices similar to the environment 120. It is to be understood that the computing devices 110 shown are intended to be illustrative only and that computing nodes and other computing environments may communicate with any type of computerized device over any type of network with direct or indirect connections.

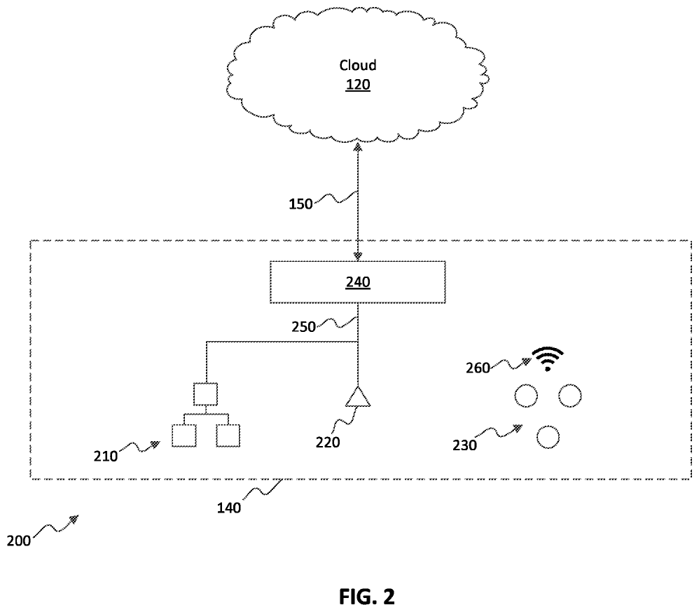

FIG. 2 illustrates exemplary devices or connected elements for a progressive network connectivity architecture 200 in which various embodiments of the present disclosure may be implemented. In this example, the structure 140 can be clearly seen as containing one or more types of connected elements 210, 220, 230, 240 for monitoring and management of the structure. These connected elements 210, 220, 230, 240 may communicate via a wired network 250 or wireless network 260 that makes the data structures from each connected element available to the network or cloud environment 120 via the network connections 150.

As before, any variety of connected elements may be used to perform sensing, actuation, data capture, storage, or processing over the network connection 150, to the shared computing environment 120, or to other parts of the structure 140. For example, the connected elements 210 may be connected sensors to measure carbon dioxide for monitoring air quality of the structure 140 and communicate via a wired network connection 250. The connected elements 220 may be both a connected sensor that detects ambient light and also an actuator to change the state of an occupant light fixture and communicate via a wired network connection 250. The connected elements 230 may be connected sensors for temperature and humidity to monitor environment of the building 140 and communicate via a wireless network connection 260. Finally, connected element 240 serves as a connected gateway to communicate with the associated connected elements 210, 220, 230, via their respective network connections 250, 260, process the data structures of each, and transmit same to a network connection 150 for transmission to the shared computing environment 120. It should be appreciated that a cloud computing environment 120, while providing additional communication paths to additional devices or systems, is not required as part of the progressive connectivity architecture 100. Again, other embodiments contemplate self-contained or stand-alone systems.

These connected elements need not be geographically localized or logically grouped in any way to utilize embodiments of this disclosure. Grouping connected elements geographically or logically may allow more economic use. A geographic grouping such as in an apartment, factory, oil refinery, or office building may be accomplished, as well as logically locating connected elements by function. One of many logical grouping examples may be locating connected end points designed to sense temperature, proximate to an occupied location to detect changes in environment. It should be appreciated that the groupings of connected endpoints may also be located on a very large geographic scale, even globally. Such global operations may be monitored through a network located in any number of facilities around the globe.

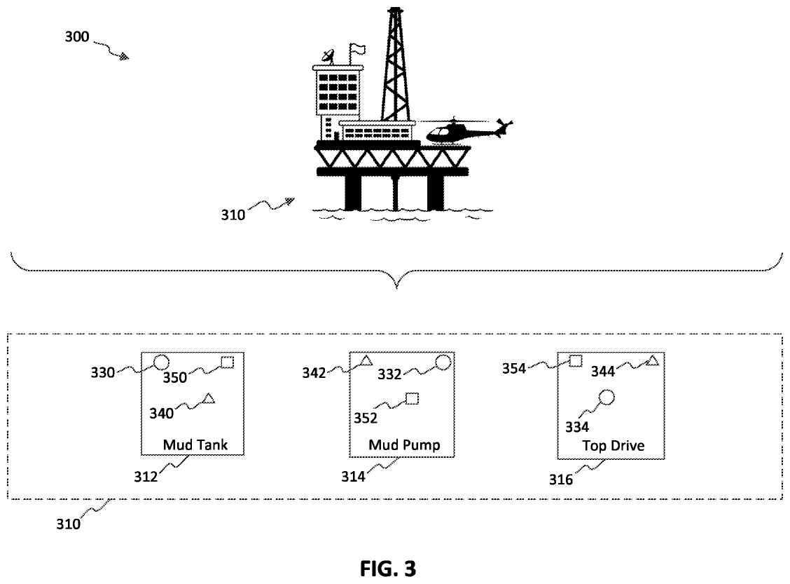

FIG. 3 illustrates an exemplary deployment of connected devices and systems for a progressive network connectivity architecture 300 in which various embodiments of the present disclosure may be implemented. In one example, an offshore oil rig 310 is shown which may contain various components and associated sensors. These components and associated sensors may include, but are not limited to, a mud tank 312 used to store drilling fluid which may include a tank level sensor 330, pressure relief valve 340, and pipe sensor pressure valve 350. A mud pump 314 which dispenses drilling fluid down to the drill string may include an ambient temperature sensor 332, a pump and motor drive 342, and a pump motor vibration sensor 352. A top drive 316 may be utilized to turn the drill string and consist of a torque sensor 334, a hydraulic rotary assembly 344, and a pressure sensor 354.

Data from each or any combination of sensors, controllers, and other connected systems may be utilized to determine current operation of the oil rig 310 and its associated components. As data is collected from the various devices, operation of the various systems may be monitored and modified based on the data presented, and/or past data which is stored may be processed with near real-time data, and/or synthetic data derived from current and historical data, and/or data from external sources. Externally sourced data may include data from other similar oil rigs or their components, weather data, seasonal data, ocean data, or any other data where correlations may be processed and utilized to create or modify information for present or future operations of the oil rig in the present example.

Data generated by a deployed system and data external to the system (e.g., weather data) may be used. A variety of such data from external sources can complement system-originating data, and can be used in the processing of present and future potential actions taken on the system. As one example, if the mud pump 314 which dispenses drilling fluid down to the drill bit reports an abnormal condition from a motor vibration sensor 352, a system may take immediate action and shut part or all of the system down to prevent future harm. In another example, if a mud tank 312 used to store drilling fluid is dependent in part on ocean salinity, which data is external to the system, such data can be processed with, for example, the tank level sensor 330 to determine what (if any) action may be necessary to the system to allow operations to continue as an operator sees fit.

Embodiments herein provide a progressive connectivity architecture that allows selective enabling and disabling of cloud-based services for subsystems that provide a number of services, including but not limited to (1) real-time data processing (2) data visualization and presentation, (3) cross-site integration, (4) data segregation, and (5) authentication and authorization. One or more of these subsystems may be provided as a part of an overall industrial control system (ICS), building management system (BMS), process automation system (PAS), and the like. It should be noted that “cloud-based services” or sometimes “cloud services” refer not only to services provided by a “cloud,” but also to any services that are provided using a network or shared computing environment, which may include a public, private, or hybrid public/private environment.

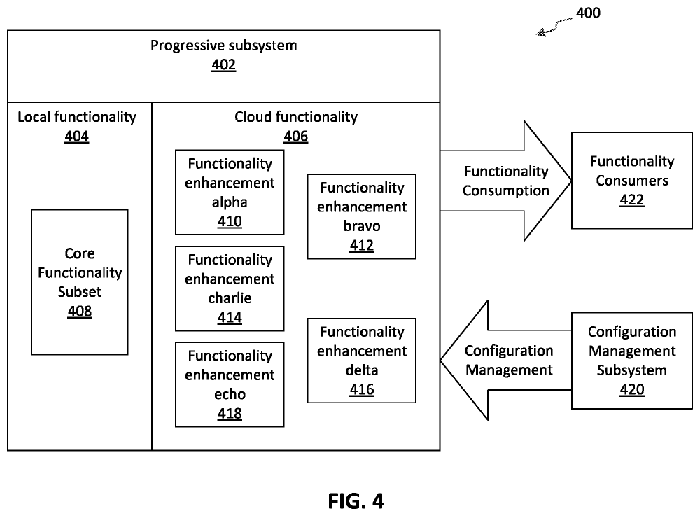

FIG. 4 illustrates an exemplary subsystem that may be used to provide one or more services, such as the services (1)-(5) mentioned above, in a progressive network connectivity architecture 400 according to some embodiments. The subsystem shown is a progressive subsystem 402 in that it has the usual traditional local functionality 404, but is also cloud-capable and configurable to provide cloud-based functionality 406 as needed, depending on how the subsystem 402 is configured/reconfigured. At the local level, the progressive subsystem 402 has a subset of core functionality 408, for example, data acquisition (e.g., receiving thermal sensor inputs), data storage (e.g., sending sensor data to a hard drive or RAID array), event detection (e.g., monitoring temperature thresholds), alert notice (e.g., sending an alert signal), and the like. In this regard, the progressive subsystem 402 may generally be considered as a modular or partially modular functionality provider.

At the cloud level, the progressive subsystem 402 can access a number of cloud-based enhancements or additions to the local subset of core functionality 408. These cloud-based functionality enhancements are shown generally as enhancement alpha 410 (e.g., cloud-based storage), enhancement beta 412 (e.g., cloud-based analytics), enhancement charlie 414 (e.g., cloud-based event detection), enhancement delta 416 (e.g., cloud-based authentication), and enhancement echo 418 (e.g., cross-site data access). A configuration management subsystem 420 manages whether and/or which of the cloud-based functionality enhancements 410-416 may or may not be accessed by the progressive subsystem 402. This arrangement allows cloud-based services to be selectively enabled and disabled for the progressive subsystem 402 according to customer and/or internal requirements. One or more functionality consumers 422, for example, a user display, notification system, and the like, may then consume the functionality provided by the progressive subsystem 402.

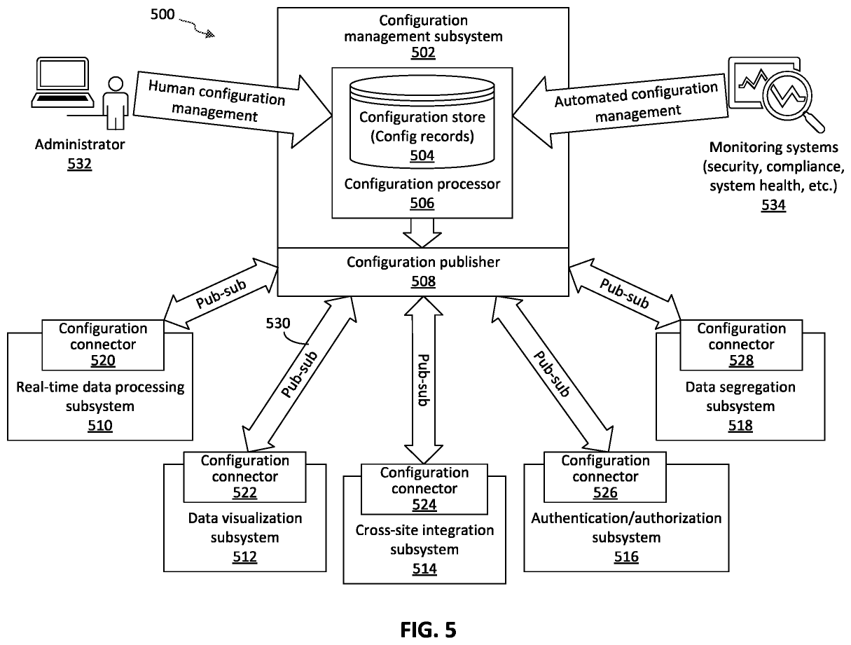

FIG. 5 illustrates an exemplary implementation of a progressive network connectivity architecture 500 where a plurality of progressive subsystems similar to the subsystem 402 from FIG. 4 may be employed to provides services. Here, as in FIG. 4, a centralized configuration management subsystem 502 operates to maintain cloud connectivity configurations for the plurality of progressive subsystems. There are five such subsystems shown, including a subsystem 510 that provides real-time data processing services, a subsystem 512 that provides data visualization services, a subsystem 514 that provides cross-site integration services, a subsystem 516 that provides authentication and authorization services, and a subsystem 518 that provides data segregation services. The cloud connectivity configurations for the subsystems 510-518 are defined or otherwise set out in configuration records stored in a configuration store 504. Each configuration record includes a configuration state (discussed later herein) for one of the subsystems 510-518. Each configuration state in turn specifies whether and/or which of the cloud-based services may or may not be provided to the one of the subsystems 510-518.

A configuration processor 506 of the configuration management subsystem 502 controls read/modify/write access to the configuration store 504 and the configuration records therein. The configuration processor 506 also operates to distribute the configuration records and any updates thereto to the progressive subsystems 510-518. The configuration updates reflect changes in cloud connectivity for one or more of the subsystems 510-518, such as a change from local-only data storage to local-plus-cloud data storage, and vice versa. These configuration updates may be received by the configuration processor 506 both manually, such as from a user 532 providing human configurations, and automatically, such as from an automated monitoring system 534 providing automated configurations.

Distribution of the configuration records to the subsystems 510-518 may occur in a number of ways, such as on a regularly scheduled basis, or when there is an update to one of the configuration records, or upon occurrence of certain events (e.g., a security breach), and the like. In the example of FIG. 5, the distribution is implemented using a publish-subscribe pattern where a centralized configuration publisher 508 sends configuration messages to a plurality of configuration connectors 520-528 (i.e., subscribers) via a subscription channel or medium 530. Each configuration connector 520-528 receives and processes configuration messages for a respective subsystem 510-518 as shown. In the publish-subscribe pattern, the configuration messages are not specifically addressed to individual configuration connectors 520-528. Rather, all configuration connectors 520-528 receive the same configuration messages, then each configuration connector 520-528 extracts and processes information from the configuration messages that is relevant to its respective subsystem 510-518.

Those skilled in the art will of course appreciate that alternative distribution methods known in the art may be implemented to disseminate configuration records besides a publish-subscribe pattern. For example, distribution methods may be used where messages are addressed specifically to individual configuration connectors, or where only configuration states are disseminated instead of entire configuration records, or where only deltas (i.e., differences) from previous configuration states or records are disseminated. Examples of alternative distribution methods that may be used include server-push methods, client-pull methods, and similar automated methods, as well as manual entry by a user.

Similarly, those skilled in the art will appreciate that any of the subsystems shown may be divided into two or more constituent subsystems and that any two or more of the subsystems may be combined into a single super subsystem. Subsystems that provide additional and/or alternative services other than the ones mentioned here are also contemplated. These subsystems and other components in FIG. 5 and throughout the drawings may be implemented as software components, hardware components, or a combination of hardware components programmed with software components, and the like.

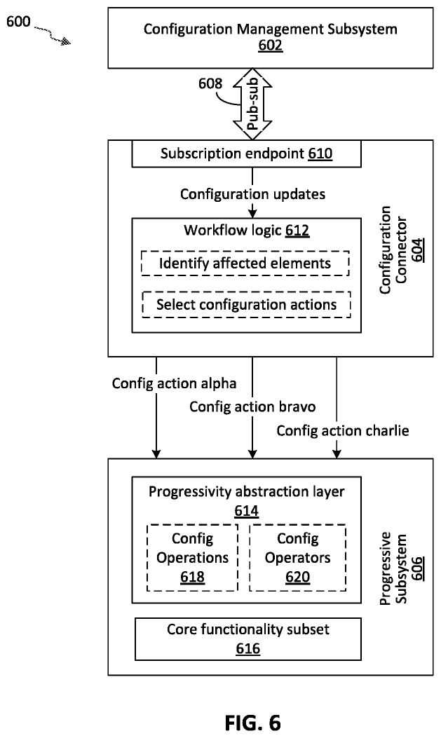

FIG. 6 illustrates an exemplary implementation of some of the components in a progressive network connectivity architecture 600 according to one or more embodiments, including. As can be seen, a centralized configuration management subsystem 602 distributes configuration updates to a configuration connector 604 for a progressive subsystem 606. The progressive subsystem 606 may be any of the progressive subsystems 510-518 from FIG. 5 or any other progressive subsystem that can provide local and cloud-based services. The configuration updates for the progressive subsystem 606 are provided to the configuration connector 604 over a publish-subscribe medium 608 in this example, but other distribution patterns may also be used.

Where a publish-subscribe pattern is used, the configuration connector 604 may include functionality that provides a subscription endpoint 610 for the publish-subscribe medium 608. The configuration updates may then be received over the publish-subscribe medium 608 and processed by a workflow logic 612 in the configuration connector 604. The workflow logic 612 determines, based on the type of progressive subsystem 606, which configuration actions need to be taken in order to carry out the changes specified in the configuration updates. More specifically, the workflow logic 612 identifies the connected elements of the subsystem 600 that are affected by the configuration updates and selects specific configuration actions needed to carry out the configuration updates. The configuration actions selected by the configuration connector 604 are generally shown here as configuration actions alpha, bravo, and charlie. These configuration actions may include, for example, open a connection to an identified cloud-based data storage at a given URL, stop further data storage on an identified local data storage, synchronize the data on the local data storage to the cloud-based data storage, and reroute future data storage from the local data storage to the cloud-based data storage. In some embodiments, the configuration connector 604 may be implemented in the form of a daemon or service that runs as a background process in the progressive subsystem 606.

In the progressive subsystem 606, a progressivity abstraction layer 614 receives the configuration actions from the configuration connector 604 and implements the configuration actions. The progressivity abstraction layer 614 basically translates the configuration actions from high-level actions (e.g., enable cloud-based data storage) into low-level operations and command that are required to perform the actions in the core functionality 616. In this regard, the progressivity abstraction layer 614 may resemble an application programming interface (API) between the configuration connector 604 and the core functionality subset 616. The progressivity abstraction layer 614 operates to expose or otherwise make the core functionality 616 available to users and other subsystems. To this end, the progressivity abstraction layer 614 includes a library of commands and operations 618 that are specific to the core functionality subset 616 of the progressive subsystem 606, along with supporting operators 620 that execute those operations. These operations 618 may then be executed by the operators 620 to effect modifications to the behavior of the core functionality subset 616 of the progressive subsystem 606. Thus, for example, if a configuration update specified that cloud-based data storage may be enabled in the progressive subsystem 606 (e.g., due to a service level agreement (SLA) change), then the progressivity abstraction layer 614 may perform, based on the configuration actions from the configuration connector 604, operations such as closing a certain data port, opening another data port, sending data through the opened data port using a data streaming protocol, and the like.

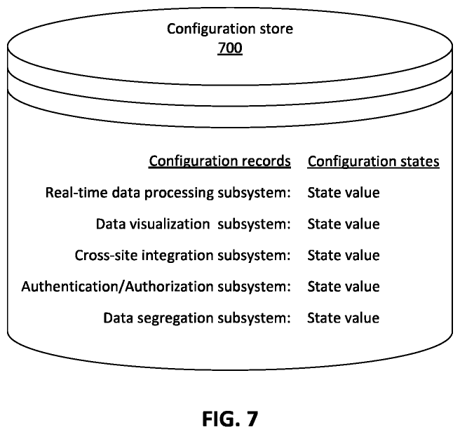

The configuration updates for a plurality of progressive subsystems may be stored in a configuration store, an exemplary implementation of which is illustrated in FIG. 7. As shown, an exemplary configuration store 700 may take the form of one or more databases that store a plurality of configuration records. In the present embodiment, each configuration record corresponds to one of the progressive subsystems and includes a configuration state that defines the cloud connectivity configurations for the subsystem. These configuration states specify whether and/or which cloud-based services may or may not be provided to the one of the subsystems and may be in the form of one or more variables representing a single value, a set of values, logical conjunctions of values, and the like, as dictated by specific requirements and capabilities of the subsystem.

Configuration Record Alpha below shows a simplistic example of a configuration record corresponding to a real-time data processing subsystem where a configuration state of “0” represents local-only connectivity and a configuration state of “1” represents local and cloud connectivity for the subsystem. A similar configuration record may be provided for each different progressive subsystem.

Configuration Record Alpha

| Subsystem Name | Configuration State |
|---|---|
| Real-time data processing subsystem | 1 |

Configuration Record Bravo below shows an example of a configuration record corresponding to a data visualization subsystem where a configuration state of “0” disables cloud connectivity for a given functionality and a configuration state of “1” enables cloud connectivity for the given functionality. It should be noted that not every available functionality needs to be specified in every configuration record, such that only those with updated or changed connectivity (i.e., deltas) are specified in some embodiments.

Configuration Record Bravo

| Subsystem Name | Configuration State | |
|---|---|---|
| Data visualization subsystem | Local data storage | 1 |
| | Cloud-based data storage | 1 |
| | Local data processing | 1 |
| | Cloud-based data processing | 0 |
| | . . . | . . . |

In addition, while the above examples of configuration records each correspond to one progressive subsystem, it is also possible to have one configuration record that applies to multiple progressive subsystems. This approach is particularly useful where a publish-subscribe pattern is used to distribute the configuration updates. In the publish-subscribe pattern, the same messages are published to all subscribing subsystems, then each subscribing subsystem extracts and processes information that is relevant to that subsystem. Configuration Record Charlie below shows an example of a configuration record for a publish-subscribe pattern that includes configuration states for multiple progressive subsystems where “0” again represents local-only connectivity and “1” again represents local plus cloud connectivity.

Configuration Record Charlie

| Subsystem Name | Configuration State |
|---|---|
| Real-time data processing subsystem | 1 |
| Data visualization subsystem | 0 |
| Cross-site integration subsystem | 1 |
| Authentication/authorization subsystem | 0 |
| Data segregation subsystem | 1 |
| . . . | . . . |

It is further possible in some embodiments for the configuration states to take integer values or Boolean (i.e., True or False) values instead of binary values. As well, the configuration states may assume a composite value, such as a bit array where several configuration updates may be represented by one configuration state. For higher complexity systems, a dictionary approach may be used where keywords may be used to indicate complex configuration updates.

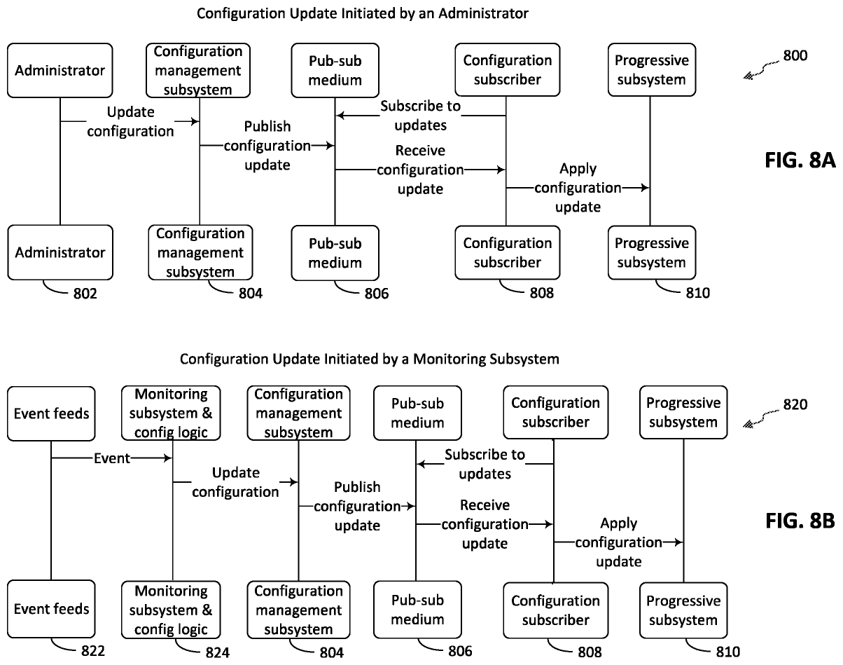

FIGS. 8A-8B illustrate exemplary configuration update sequences for a progressive network connectivity architecture according to one or more embodiments. As mentioned earlier, the configuration updates for the progressive subsystems may be provided by a human administrator in some embodiments or they may be provided by an automated monitoring subsystem in some embodiments. FIG. 8A shows an exemplary update sequence 800 reflecting configuration updates provided by a human administrator 802. The sequence 800 generally begins with the human administrator 802 updating a configuration record for a given subsystem through a centralized configuration management subsystem 804. The configuration management subsystem 804 publishes the configuration updates via a publish-subscribe medium 806 to one or more configuration subscribers 808, such as the configuration connectors mentioned previously (see FIG. 5). The one or more configuration subscribers 808 receive the configuration updates and apply them to respective ones of the progressive subsystems.

FIG. 8B shows an exemplary update sequence 820 reflecting configuration updates provided by an automated monitoring subsystem 824. The sequence 820 generally begins with the automated monitoring subsystem 824 receiving notification and/or information regarding an event from one or more event feeds 822. The event feeds 822 may be any suitable sources of events, occurrences, and the like, including publicly available as well as proprietary sources. Examples of event feeds 822 may include news feeds, weather feeds, market feeds, and the like. The automated monitoring subsystem 824 then uses configuration logic to process the events from the event feeds 822 and determines whether an update should be made to the connectivity configuration for any one of the progressive subsystems. Examples of events requiring a configuration update to a progressive subsystem may include a data breach at a vendor, a service outage at a service provider, a natural disaster, a terrorist attack, and the like. The automated monitoring subsystem 824 thereafter updates the configurations for any affected progressive subsystem through the configuration management subsystem 804. The sequence 820 proceeds from this point in a similar manner to the sequence 800 shown in FIG. 8A.

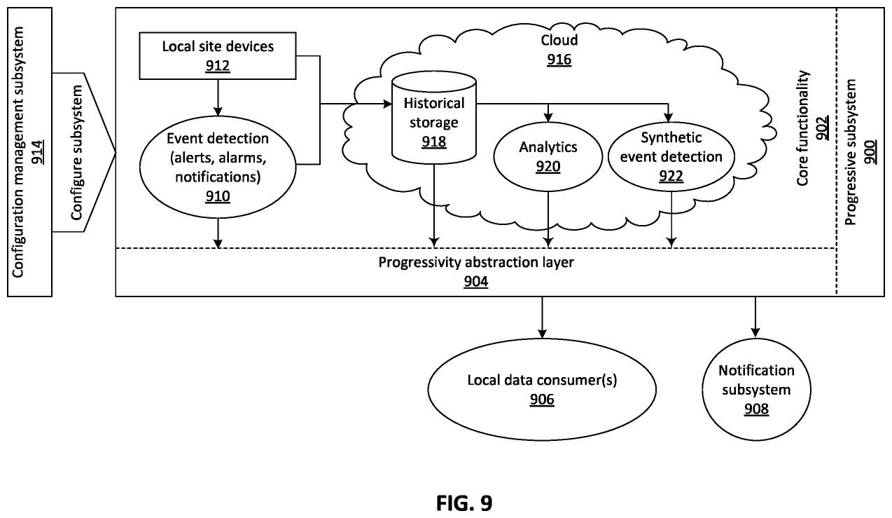

Following now in FIG. 9 and the figures that follow are exemplary progressive subsystem implementations using a progressive network connectivity architecture according to one or more embodiments herein.

Turning to FIG. 9, an exemplary implementation is shown for a progressive real-time data processing subsystem 900 according to embodiments herein. As this figure shows, in general, a progressive cloud architecture may be used to achieve progressive cloud functionality for near real-time data processing. In a local subsystem, such functionality may include processing real-time data streams and event, alert, and/or alarm detections, and expose real-time outputs to the user. In a more connected subsystem, such functionally may include historization of event, alert, and/or alarm data, as well as making the data available for analysis. Exposure of real-time analytics and historical data to the user, both local and remote, is also contemplated. It should be appreciated that, as with some progressive cloud architectures, the variability between local and connected system topology may be configurable. A progressive cloud architecture may be designed to accommodate wide system variability, thus allowing a user or system to determine the mode of operation.

Referring to FIG. 9, the subsystem 900, like previous progressive subsystems, includes a subset of core functionality 902 and a progressivity abstraction layer 904. The abstraction layer 904 operates to present or otherwise make the core functionality 902 available to local data consumers 906 and other subsystems 908 (e.g., a notification subsystem). This core functionality 902 may include any core functionality suitable for a system of which the subsystem 900 forms a part. Examples may include an industrial control system (ICS), a building management system (BMS), a process automation system (PAS), and the like. In the case of a building management system, for example, the core functionality 902 may include real-time event detection functionality 910, such as real-time alert, alarm, and notification functionality based on data received from one or more local devices 912 (e.g., computing devices, communication devices, security devices, sensing devices, etc.).

In accordance with one or more embodiments, a centralized configuration management subsystem 914 provides connectivity configuration updates for the subsystem 900. The connectivity configuration updates may specify, for example, that cloud-based services may now be enabled (or disabled) for the event detection functionality 910 as result of a recent service level agreement (SLA) change, local data processing capacity, and the like. Putting in the connectivity update (i.e., by the progressivity abstraction layer 904) allows the event detection functionality 910 and the local devices 912 to access and interact with additional and/or enhanced functionality available in the cloud 916. Such additional and/or enhanced functionality may include for example, historical data storage 918, additional data analytics 920, synthetic event detection 922, and the like. The synthetic event detection 922 may be particularly useful, for example, in a process automation system where an otherwise acceptable increase in several individual parameters (e.g., temperature, pressure, humidity) may actually indicate an imminent fault (e.g., equipment failure) if the parameter increases occur at nearly the same time.

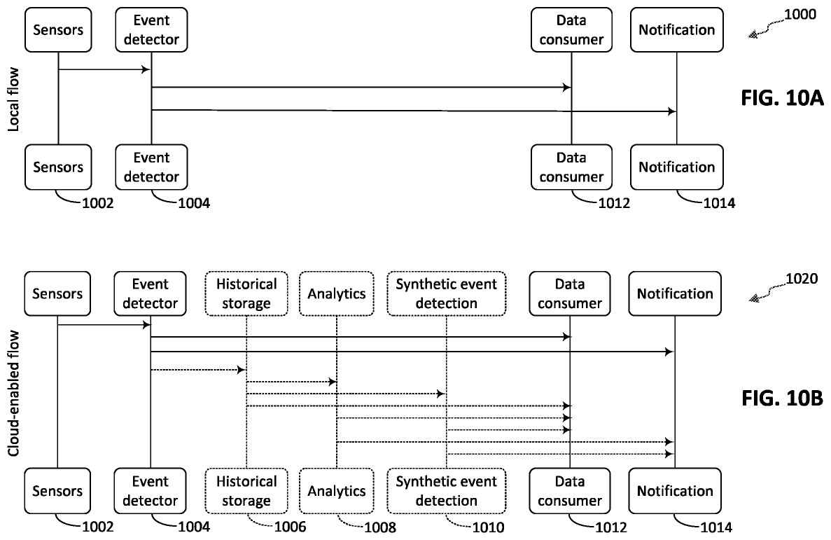

The foregoing operations are illustrated in FIGS. 10A-10B, which show exemplary workflows or sequences for a real-time data processing subsystem according to embodiments of this disclosure. In FIG. 10A, a real-time data processing workflow or sequence 1000 is shown that relies on local data processing only. The sequence 1000 generally begins with one or more sensing devices or sensors 1002 providing sensor data to an event detector 1004. The sensors 1002 may include temperature sensors, humidity sensors, pressure sensors, occupancy sensors, and the like. The event detector 1004 performs real-time local data processing on the sensor data from the sensors 1002 to determine whether one or more predefined events, such as a temperature or pressure threshold being exceeded, have occurred based on the sensor data. Events that are detected by the event detector 1004 are provided to a data consumer 1012 for taking appropriate actions (e.g., powering down equipment), as well as to a notification system 1014 for sending out appropriate notifications.

FIG. 10B shows an exemplary real-time data processing workflow or sequence 1020 that relies on both local as well as cloud-based data processing. The sequence 1020 is similar to the sequence 1000 from FIG. 10A, except that cloud-based services (see dotted lines) have now been enabled (or disabled) for the real-time data processing subsystem. Thus, in addition to locally processing the sensor data from the sensors 1002, the event detector 1004 can also access and employ several functionality enhancements available in the cloud for the sensor data. These enhancements may include, for example, cloud-based historical data storage 1006, cloud-based real-time data analytics 1008, and synthetic event detection 1010.

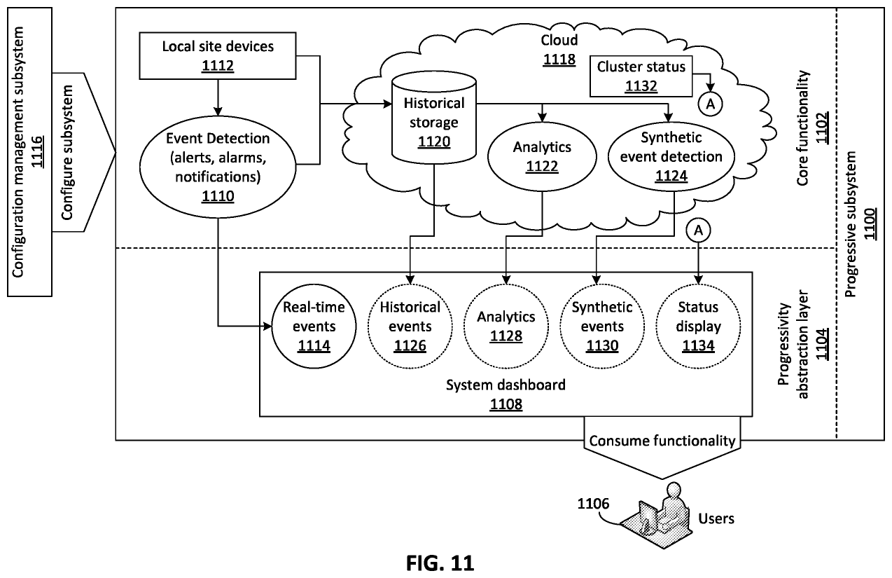

FIG. 11 illustrates an exemplary implementation of a data visualization subsystem 1100 according to one or more embodiments. As this figure shows, in general, data visualization and integration in a local subsystem may be used to present on-premises data streams using on-premises visualization and presentation systems. A more connected subsystem may present both on-premises and cloud-based data streams using on-premises presentation systems. Such a presentation framework may be flexible and able to accommodate and present a wide variety of data streams ranging from local to remote, as configured by a user or system. It should be appreciated these embodiments and other embodiments discussed herein may represent lo-based systems and methods, but may also be applicable to non-IoT systems and methods. As one example, instead of streaming raw sensor data, the real-time data streams may be system health readings from a data center (e.g., CPU load, memory consumption, IO utilization, etc.) or any other type of raw data upon which feature detection and subsequent processing may be done.

Referring to FIG. 11, as with other progressive subsystems, the subsystem 1100 includes a subset of core functionality 1102 and a progressivity abstraction layer 1104. As before, the abstraction layer 1104 operates to expose or otherwise make the core functionality 1102 available to local user 1106 in the form of a system dashboard 1108 that includes one or more displays or other visual and/or audio presentation mechanisms. This core functionality 1102 may include, for example, event detection functionality 1110 based on sensor data received from one or more local devices 1112. Detected events are then displayed or otherwise presented to the users 1106 on a real-time events display 1114 of the system dashboard 1108.

In accordance with one or more embodiments, a centralized configuration management subsystem 1116 provides connectivity configuration updates for the subsystem 1100. These updates may specify that cloud-based services may now be enabled (or disabled) for the event detection functionality 1110, for example. Implementing the connectivity update (i.e., by the progressivity abstraction layer 1104) allows the event detection functionality 1110 to access additional and/or enhanced functionality available in the cloud 1118. The additional and/or enhanced functionality may include for example, historical data storage 1120, additional data analytics 1122, synthetic event detection 1124, and the like. The results of these cloud-based additional and/or enhanced functionality 1120, 1122, 1124 may then be displayed or otherwise presented to the users 1106 via cloud-based displays (shown in dotted lines) on the system dashboard 1108. For example, there may be a historical events display 1126, and analytics display 1128, and a synthetics events display 1130. In some embodiments, a cloud-based cluster status functionality 1132 may also be accessed via the cloud 1118 and the cluster status displayed on a status display 1134 of the system dashboard 1108.

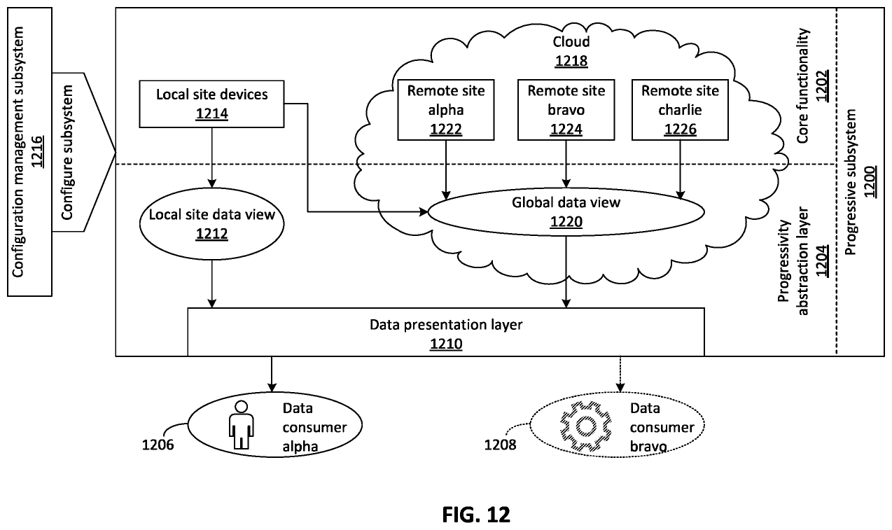

FIG. 12 illustrates an exemplary implementation of a cross-site integration subsystem 1200 according to one or more embodiments. As seen in this figure, in general, cross-site integration in a local subsystem may be used to perform site-specific actions, such as site-specific workflow configuration, while a more connected subsystem may perform additional actions, such as cross-site workflow configuration across a customer's entire multi-site install base or enterprise.

Referring to FIG. 12, the subsystem 1200, like its previous counterparts, includes a subset of core functionality 1202 and a progressivity abstraction layer 1204. The abstraction layer 1204 again operates to present or otherwise make the core functionality 1202 available to local data consumers 1206 (e.g., users, systems) and remote data consumers 1208 (shown in dotted lines) in the form of a data presentation layer 1210 that includes one or more displays or other visual and/or audio presentation mechanisms. The core functionality 1202 here may include, for example, local site data viewing functionality 1212 of various types of data from local devices 1214 through the data presentation layer 1210.

In accordance with one or more embodiments, a centralized configuration management subsystem 1216 provides connectivity configuration updates for the subsystem 1200. These updates may enable (or disable) cloud-based services for the local devices 1214, for example. Implementing the connectivity update (i.e., by the progressivity abstraction layer 1204) allows the local devices 1214 to access the cloud 1218 and send their data to a cloud-based global data viewing functionality 1220. One or more remote sites 1222, 1224, 1226 may then view the data from the local devices 1214 via the global data viewing functionality 1220.

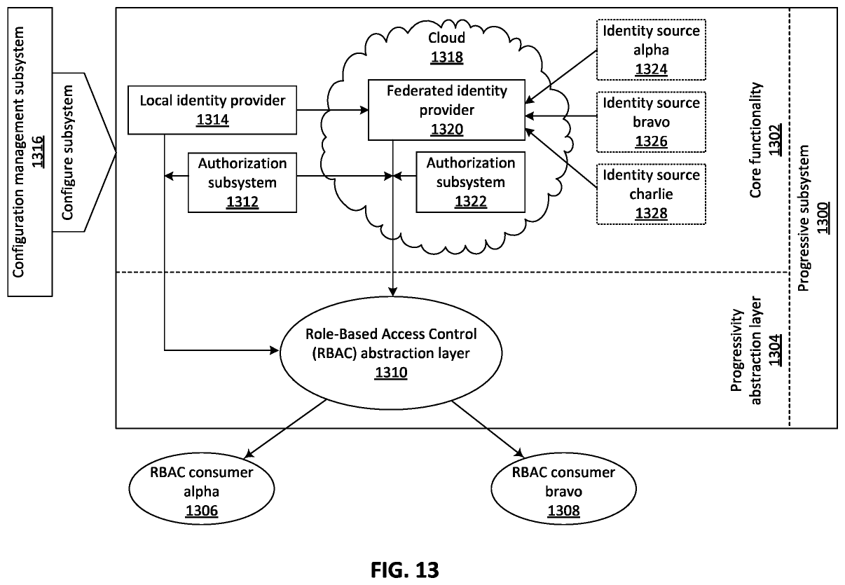

FIG. 13 illustrates an exemplary implementation of an authentication and authorization subsystem 1300 according to one or more embodiments. As evident in this figure, in general, authentication and authorization in a local subsystem may be used to offer product specific functionality. A more connected subsystem may integrate with a cloud-accessible authentication/authorization provider, which may be an existing authentication/authorization provider with public integration endpoint. Examples of a cloud-accessible authentication/authorization provider may include, but are not limited to, the ADFS (Active Directory Federation Services) from Microsoft, or a third-party authentication/authorization provider that would federate with the ADFS, such as a Schneider IDMS federating with the ADFS.

Referring to FIG. 13, the subsystem 1300, similarly to previous progressive subsystems, includes a subset of core functionality 1302 and a progressivity abstraction layer 1304. As before, the abstraction layer 1304 operates to expose or otherwise make the core functionality 1302 available to local data consumers 1306 (e.g., users) and 1308 (e.g., systems) in the form of a role-based access control (RBAC) abstraction layer 1310. The core functionality 1302 here may include an authorization subsystem 1312 that controls different levels of access (e.g., user, admin, etc.) users may have to the subsystem 1300 and a local identity provider (IdP) 1314 that verifies and authenticates users in the subsystem 1300.

In accordance with one or more embodiments, a centralized configuration management subsystem 1316 provides connectivity configuration updates for the subsystem 1300. The configuration updates may specify, for example, that cloud-based services may now be enabled (or disabled) for the authorization subsystem 1312 and the local identity provider 1314. Performing the connectivity update (i.e., by the progressivity abstraction layer 1304) allows the authorization subsystem 1312 and the local identity provider 1314 to access and interact with additional and/or enhanced functionality available in the cloud 1318. The additional and/or enhanced functionality may include, for example, a federated identity provider 1320, a cloud-based authorization subsystem 1322, and the like. The federated identity provider 1320 may in turn access additional cloud-based identification sources, such as an identity source alpha 1324, an identity source bravo 1326, and an identity source charlie 1328. The additional functionality provided by the federated identity provider 1320 and the cloud-based authorization subsystem 1322 may then be used to authenticate and authorize the data consumers 1306, 1308 through the RBAC abstraction layer 1310.

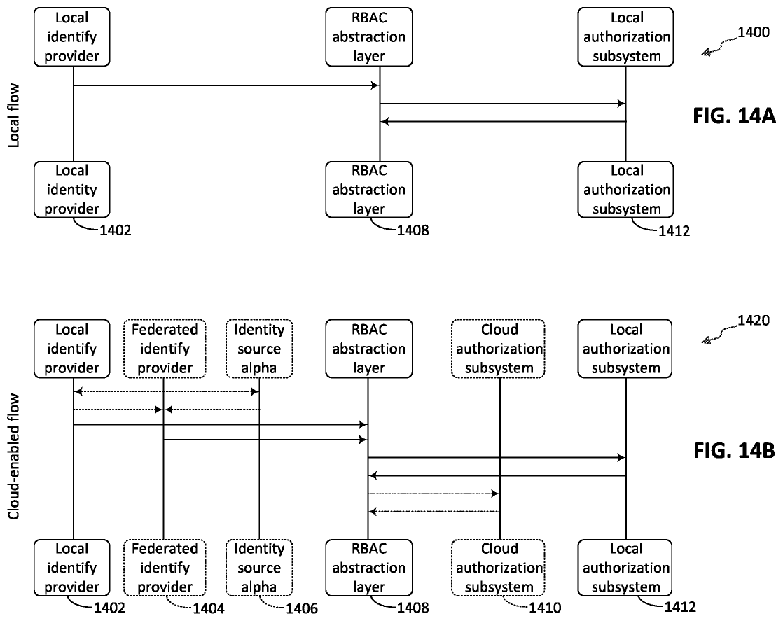

FIGS. 14A-14B illustrate exemplary workflows or sequences for an authentication/authorization subsystem according to some embodiments. In FIG. 14A, an authentication/authorization workflow or sequence 1400 is shown that relies on local processing only. The sequence 1400 generally begins with a user submitting his/her credentials to a local identity provider (IdP) 1402 for authentication. The local identity provider 1402 checks the user's credentials using its local databases of credentials and, if found to be valid, authenticates the identity of the user to an RBAC abstraction layer 1408. Once the identity is locally authenticated, the RBAC abstraction layer 1408 checks with the local authorization system 1412 to determine what is an appropriate level of local access for the user. The local authorization system 1412 then returns the appropriate level of local access to the RBAC abstraction layer 1408 based the user's identify. The RBAC abstraction layer 1408 thereafter performs certain operations (e.g., issues a secure key) to allow (or prohibit) user access to the subsystem accordingly.

FIG. 14B shows an exemplary authentication/authorization workflow or sequence 1420 that relies on both local as well as cloud-based processing. The sequence 1420 is similar to the sequence 1400 from FIG. 14A, except that cloud-based services (see dotted lines) have now been enabled (or disabled) for the authentication/authorization subsystem. Specifically, in addition to checking the user's credentials using local databases, the local identity provider 1402 can also provide the user's credentials to a federated identity provider 1404. The federated identity provider 1400 then checks the user's credential using one or more cloud-based identity sources 1406. If the credentials are determined to be valid, then the identity of the user is authenticated to the RBAC abstraction layer 1408. Once the cloud-based identity is authenticated, the RBAC abstraction layer 1408 checks with a cloud-based authorization system 410 to determine which cloud-based subsystems the user may access and the levels of access. The local authorization system 1410 then returns the appropriate level of local access to the RBAC abstraction layer 1408. The RBAC abstraction layer 1408 thereafter performs certain operations (e.g., issues a secure key) to allow (or prohibit) user access to the cloud-based subsystems accordingly.

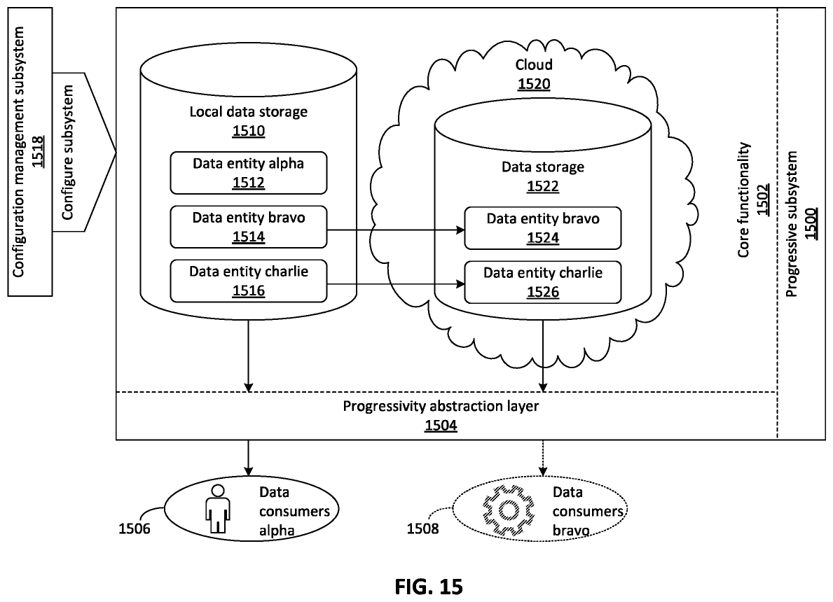

FIG. 15 illustrates an exemplary implementation of a data segregation subsystem 1500 according to one or more embodiments. As can be seen here, in general, data segregation in a local subsystem may be used to segregate all data entities locally, while a more connected subsystem may segregate some or all data entities in cloud-based storage. This allows cloud-based functionality components across a multisite enterprise to access and utilize the data entities. Additionally, this approach facilitates separating data entities that may be authorized for storage in the cloud from data entities that are not authorized for cloud storage. Reasons for this segregation may include, but are not limited to, security, privacy, and/or reliability.

Referring to FIG. 15, the subsystem 1500, in keeping with previous progressive subsystems, includes a subset of core functionality 1502 and a progressivity abstraction layer 1504. The abstraction layer 1504 operates to present or otherwise make the core functionality 1502 available to local data consumers 1506 (e.g., users) and 1508 (e.g., systems). The core functionality 1502 in this example may include a local data storage 1510 (e.g., one or more hard drives, RAID array, etc.) that provides local data storage for various data entities, including data entity alpha 1512, data entity bravo 1514, and data entity charlie 1516.

In accordance with one or more embodiments, a centralized configuration management subsystem 1516 provides connectivity configuration updates for the subsystem 1500. The configuration updates may specify, for example, that cloud-based services may now be enabled (or disabled) for one or more of the data entities 1512, 1514, 1516. Putting in the connectivity update (i.e., by the progressivity abstraction layer 1504) allows the subsystem 1500 to upload the one or more data entities 1512, 1514, 1516 to a cloud-based storage 1522 in the cloud 1520 where the data entities may be segregated. In the present example, the configuration update enabled cloud-based storage for data entity alpha 1512 and data entity bravo 1514, whereas data entity charlie 1516 continued to be stored locally only.

A number of advantages and benefits are readily evident from embodiments of a progressive network connectivity architecture as disclosed herein. For example, companies and organizations that are new to the cloud may not wish to connect everything all at once to such a shared environment. Similarly, companies that gather sensitive data and/or provide sensitive services, such as those involving customer privacy data, proprietary technical and business information, and the like, may not wish to expose all of their data and applications to the cloud. Indeed, certain regulatory jurisdictions prohibit companies from storing customer privacy data on the cloud or even processing (e.g., performing analytics) the data without express customer authorization. These companies would benefit from a more deliberate and controlled approach to network connectivity. Embodiments of a progressive network connectivity architecture allow companies and enterprises to selectively and dynamically configure and reconfigure network connectivity for one or more subsystems both manually and automatically to enable and disable network or cloud-based services in response to internal and/or external events as needed. Any significant event may trigger a manual or automatic update in connectivity configuration, including service outages, new and/or revised privacy and other regulatory requirements, changes in service level agreements, security breaches, and the like.

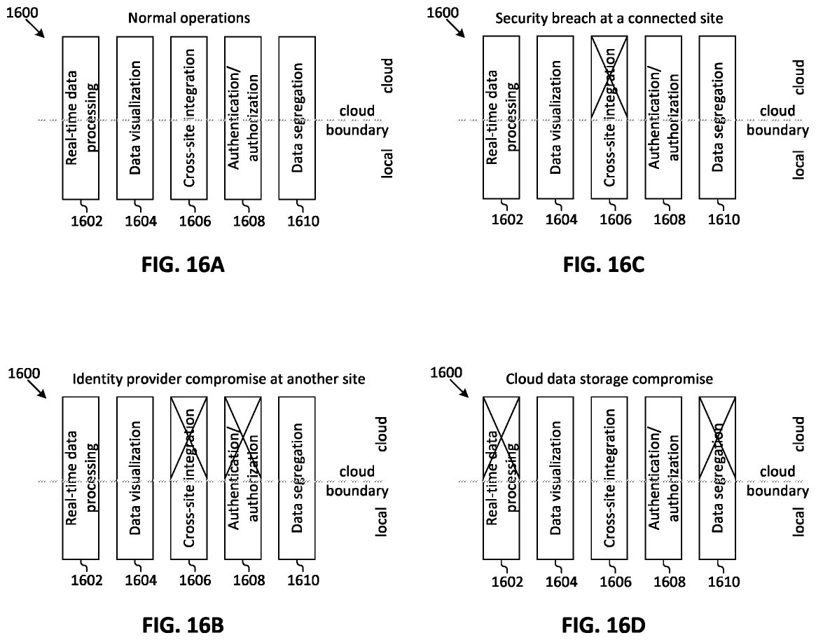

FIGS. 16A-16D illustrate exemplary responses to security breaches in a progressive network connectivity architecture according to one or more embodiments disclosure. Referring to FIG. 16A, a plurality of subsystems for a company or enterprise system 1600 are shown having a progressive network connectivity architecture. The company or enterprise system 1600 may be, for example, a multi-site enterprise system and the progressive subsystems may include, for example, a real-time data processing subsystem 1602, a data visualization subsystem 1604, a cross site integration subsystem 1606, and authentication/authorization subsystem 1608, and a data segregation subsystem 1610. These subsystems 1602-1610 are capable of both local and cloud connectivity under normal operating conditions, with the boundary therebetween represented conceptually as a dashed line.

FIG. 16B shows a scenario where an identity provider (IdP) at another site of the enterprise system 1600 has been hacked or otherwise compromised and user credentials may have been stolen. In such a scenario, the progressive network connectivity architecture of the enterprise system 1600 allows it to respond dynamically, for example, by immediately reconfiguring the cross-site integration subsystem 1606 and the authentication/authorization subsystem 1608 to disable cloud connectivity, as those subsystems are the ones most significantly affected. Local connectivity, however, is not reconfigured for any of the subsystems.

In a similar manner, FIG. 16C shows a scenario where a security breach has occurred at another connected site of the enterprise system 1600 and unauthorized personnel may have gained access to computers at that site. In this scenario, the progressive network connectivity architecture of the enterprise system 1600 allows it to again respond dynamically, for example, by immediately reconfiguring the cross-site integration subsystem 1606 to disable cloud connectivity so the breached site cannot access data at other connected sites. Again, local connectivity is not reconfigured for any of the subsystems.

FIG. 16D shows a scenario where a provider of cloud-based data storage for the enterprise system 1600 has been compromised and unauthorized personnel may have gained access the cloud-based data storage. In that scenario, the progressive network connectivity architecture of the enterprise system 1600 allows it to respond dynamically, for example, by reconfiguring the real-time data processing subsystem 1602 and the data segregation subsystem 1610 to disable cloud connectivity at least until cloud-based data storage becomes available again. Meanwhile, all of the subsystems may continue to operate using local connectivity.

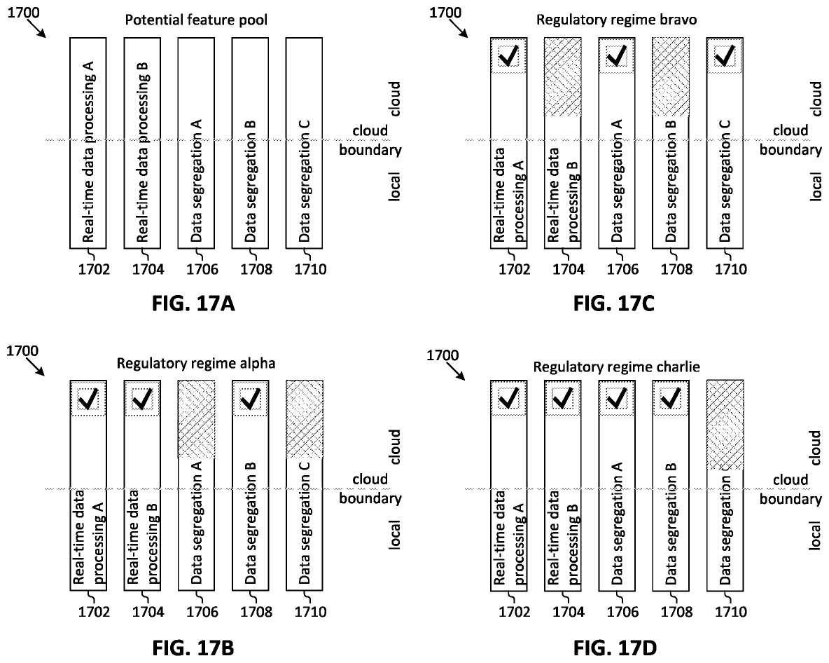

Privacy and other regulatory requirements may also be more easily complied with using a progressive network connectivity architecture according to one or more embodiments, as illustrated in FIGS. 17A-17D. Referring to FIG. 17A, a plurality of subsystems for a company or enterprise system 1700 are again shown having a progressive network connectivity architecture. As with the previous embodiment, the company or enterprise system 1700 may be a multi-site enterprise system. However, the progressive subsystems here may include a first real-time data processing subsystem A (1702), a second real-time data processing system B (1704), a first data segregation subsystem A (1706), a second data segregation subsystem B (1708), and a third data segregation subsystem C (1710). These subsystems 1702-1710 represent a potential feature pool or set that may be installed at a desired location and are capable of both local and cloud connectivity under normal operating conditions, with the boundary therebetween represented conceptually as a dashed line.

FIG. 17B shows a scenario where the enterprise system 1700 is required to comply with a given regulatory regime, indicated generally here as regulatory regime alpha, that prohibits certain data from being processed (e.g., for analytics) or stored in cloud-based storage. In this example, the prohibited data is handled by the first and third data segregation subsystems A and C. In such a scenario, the progressive network connectivity architecture of the enterprise system 1700 allows it to reconfigure these two data segregation subsystems A and C to disable cloud connectivity. Local connectivity, however, is not affected for any of the subsystems.

Similarly, FIG. 17C shows a scenario where the enterprise system 1700 is required to comply with another regulatory regime, indicated generally here as regulatory regime bravo, that prohibits certain data from being processed using cloud-based data processing and other data from being stored in cloud-based storage. In this example, the prohibited data is handled by the second real-time data processing subsystem B as well as the second data segregation system B. In such a scenario, the progressive network connectivity architecture of the enterprise system 1700 allows it to reconfigure these two subsystems B and B to disable cloud connectivity. Again, local connectivity is not affected for any of the subsystems.

FIG. 17D shows a scenario where the enterprise system 1700 is required to comply with a different regulatory regime, indicated generally here as regulatory regime charlie, that only prohibits certain data handled by the third data segregation system C from being stored in cloud-based storage. In such a scenario, the progressive network connectivity architecture of the enterprise system 1700 allows it to reconfigure the third data segregation subsystem C to disable cloud connectivity. All subsystems again may continue to operate with local connectivity.

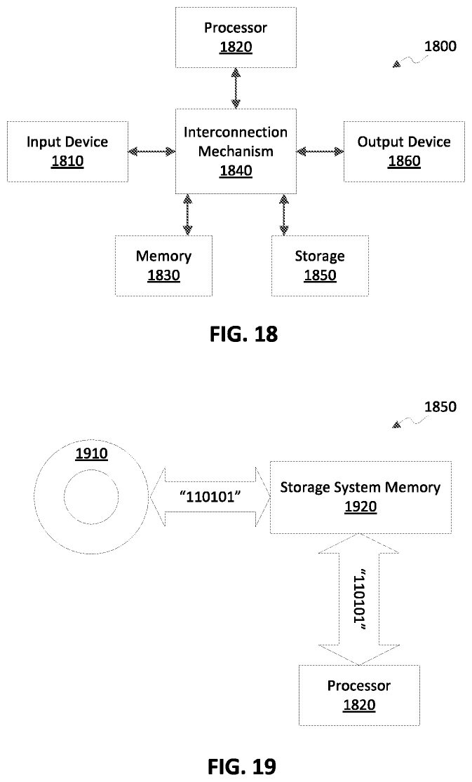

FIG. 18 illustrates an exemplary computing system that may be used to implement various embodiments of this disclosure. In general, any general-purpose computer systems used in various embodiments of this disclosure may be, for example, general-purpose computers such as those based on Intel Pentium-type processor, Motorola PowerPC, Sun UltraSPARC, Hewlett-Packard PA-RISC processors, or any other type of processor. Such computer systems may be either physical or virtual.

For example, various embodiments of the disclosure may be implemented as specialized software executing in a general-purpose computer system 1800 such as that shown in FIG. 18. The computer system 1800 may include a processor 1820 connected to one or more memory devices 1830, such as a disk drive, memory, or other device for storing data. Memory 1830 is typically used for storing programs and data during operation of the computer system 1800. The computer system 1800 may also include a storage system 1850 that provides additional storage capacity. Components of computer system 1800 may be coupled by an interconnection mechanism 1840, which may include one or more busses (e.g., between components that are integrated within the same machine) and/or a network (e.g., between components that reside on separate discrete machines). The interconnection mechanism 1840 enables communications (e.g., data, instructions) to be exchanged between system components of system 1800.

Computer system 1800 also includes one or more input devices 1810, for example, a keyboard, mouse, trackball, microphone, touch screen, and one or more output devices 1860, for example, a printing device, display screen, speaker. In addition, computer system 1800 may contain one or more interfaces (not shown) that connect computer system 1800 to a communication network (in addition or as an alternative to the interconnection mechanism 1840).

Existing system architectures are not configurable to progressively change which services are supported by and provided to subsystems. This deficiency in current system architectures is a technical problem. An exemplary embodiment of the system for progressively enabling or disabling network-based services to a plurality of subsystems may comprise a configuration store with updatable configuration records corresponding to a subsystem and including a configuration state for the subsystem. The updatable configuration state may specify which services may be provided to the subsystem and may be distributed to a configuration connector in the subsystem. The subsystem may be provided services as specified by the updated configuration state and the subsystem configuration may be modified to support the services as specified by the updated configuration state. At least this foregoing combination of features comprises an architecture that serves as a technical solution to the foregoing technical problem. This technical solution is not routine, is unconventional, and is not well-understood in the field of shared computing services in an environment such as a network or the cloud. This technical solution is a practical application of the exemplary architecture at least because it solves the foregoing technical problem and constitutes an improvement in the technical field of network-based or cloud-based computing services at least by allowing the architecture to be configurable.

The storage system 1850, shown in greater detail in FIG. 19, typically includes a computer readable and writeable nonvolatile recording medium 1910 in which signals are stored that define a program to be executed by the processor 1820 or information stored on or in the medium 1910 to be processed by the program to perform one or more functions associated with embodiments described herein. The medium may, for example, be a disk or flash memory. Typically, in operation, the processor 1820 causes data to be read from the nonvolatile recording medium 1910 into storage system memory 1920 that allows for faster access to the information by the processor than does the medium 1910. This storage system memory 1920 is typically a volatile, random access memory such as a dynamic random-access memory (DRAM) or static memory (SRAM). This storage system memory 1920 may be located in storage system 1850, as shown, or in the system memory 1830. The processor 1820 generally manipulates the data within the memory system 1830 1920 and then copies the data to the medium 1910 after processing is completed. A variety of mechanisms are known for managing data movement between the medium 1910 and the integrated circuit memory element 1830, 1920, and the disclosure is not limited thereto. The disclosure is not limited to a particular memory system 1830 or storage system 1850.

The computer system may include specially-programmed, special-purpose hardware, for example, an application-specific integrated circuit (ASIC). Aspects of the disclosure may be implemented in software, hardware or firmware, or any combination thereof. Further, such methods, acts, systems, system elements and components thereof may be implemented as part of the computer system described above or as an independent component.

Although computer system 1800 is shown by way of example as one type of computer system upon which various aspects of the disclosure may be practiced, it should be appreciated that aspects of the disclosure are not limited to being implemented on the computer system as shown in FIG. 19. Various aspects of the disclosure may be practiced on one or more computers having a different architecture or components shown in FIG. 19. Further, where functions or processes of embodiments of the disclosure are described herein (or in the claims) as being performed on a processor or controller, such description is intended to include systems that use more than one processor or controller to perform the functions.

Computer system 1800 may be a general-purpose computer system that is programmable using a high-level computer programming language. Computer system 1800 may be also implemented using specially programmed, special purpose hardware. In computer system 1800, processor 1820 is typically a commercially available processor such as the well-known Pentium class processor available from the Intel Corporation. Many other processors are available. Such a processor usually executes an operating system which may be, for example, the Windows 185, Windows 188, Windows NT, Windows 2000, Windows ME, Windows XP, Vista, Windows 7, Windows 19, or progeny operating systems available from the Microsoft Corporation, MAC OS System X, or progeny operating system available from Apple Computer, the Solaris operating system available from Sun Microsystems, UNIX, Linux (any distribution), or progeny operating systems available from various sources. Many other operating systems may be used.

The processor and operating system together define a computer platform for which application programs in high-level programming languages are written. It should be understood that embodiments of the disclosure are not limited to a particular computer system platform, processor, operating system, or network. Also, it should be apparent to those skilled in the art that the present disclosure is not limited to a specific programming language or computer system. Further, it should be appreciated that other appropriate programming languages and other appropriate computer systems could also be used.

One or more portions of the computer system may be distributed across one or more computer systems coupled to a communications network. For example, as discussed above, a computer system that determines available power capacity may be located remotely from a system manager. These computer systems also may be general-purpose computer systems. For example, various aspects of the disclosure may be distributed among one or more computer systems configured to provide a service (e.g., servers) to one or more client computers, or to perform an overall task as part of a distributed system. For example, various aspects of the disclosure may be performed on a client-server or multi-tier system that includes components distributed among one or more server systems that perform various functions according to various embodiments of the disclosure. These components may be executable, intermediate (e.g., IL) or interpreted (e.g., Java) code which communicate over a communication network (e.g., the Internet) using a communication protocol (e.g., TCP/IP). For example, one or more database servers may be used to store device data, such as expected power draw, that is used in designing layouts associated with embodiments of the present disclosure.

It should be appreciated that the disclosure is not limited to executing on any particular system or group of systems. Also, it should be appreciated that the disclosure is not limited to any particular distributed architecture, network, or communication protocol.

Various embodiments of the present disclosure may be programmed using an object-oriented programming language, such as SmallTalk, Java, C++, Ada, or C# (C-Sharp). Other object-oriented programming languages may also be used. Alternatively, functional, scripting, and/or logical programming languages may be used, such as BASIC, Fortran, Cobol, TCL, or Lua. Various aspects of the disclosure may be implemented in a non-programmed environment (e.g., analytics platforms, or documents created in HTML, XML or other format that, when viewed in a window of a browser program render aspects of a graphical-user interface (GUI) or perform other functions). Various aspects of the disclosure may be implemented as programmed or non-programmed elements, or any combination thereof.

Embodiments of a systems and methods described above are generally described for use in relatively large data centers having numerous equipment racks; however, embodiments of the disclosure may also be used with smaller data centers and with facilities other than data centers. Some embodiments may also be a very small number of computers distributed geographically so as to not resemble a particular architecture.

In embodiments of the present disclosure discussed above, results of analyses are described as being provided in real-time. As understood by those skilled in the art, the use of the term real-time is not meant to suggest that the results are available immediately, but rather, are available quickly giving a designer the ability to try a number of different designs over a short period of time, such as a matter of minutes.

Having thus described several aspects of at least one embodiment of this disclosure, it is to be appreciated various alterations, modifications, and improvements will readily occur to those skilled in the art. Such alterations, modifications, and improvements are intended to be part of this disclosure, and are intended to be within the spirit and scope of the disclosure. Accordingly, the foregoing description and drawings are by way of example only.

While particular aspects, implementations, and applications of the present disclosure have been illustrated and described, it is to be understood that the present disclosure is not limited to the precise construction and compositions disclosed herein and that various modifications, changes, and variations may be apparent from the foregoing descriptions without departing from the scope of the disclosed embodiments as defined in the appended claims.

1. A system for progressively enabling or disabling network-based services provided to a plurality of subsystems, comprising:
a configuration store having a plurality of configuration records therein, wherein one or more configuration records correspond to a subsystem and include a configuration state for the subsystem, and wherein one or more configuration states specify which network-based services may be provided to the subsystem; and
a configuration processor coupled to communicate with the configuration store, the configuration processor operable to update the configuration records in the configuration store to include updated configuration states and to distribute the updated configuration states to the subsystem for processing by a configuration connector in the subsystem, the configuration connector operable to identify one or more configuration actions that need to be performed to modify a configuration of the subsystem based on an updated configuration state for the sub system;
wherein the subsystem is provided with network-based services as specified by an updated configuration state for the subsystem and wherein the configuration of the subsystem is modified to support the network-based services as specified by the updated configuration state for the subsystem.

2. The system of claim 1, wherein the subsystems comprise a plurality of connected elements that consume network-based services.

3. (canceled)

4. (canceled)

5. (canceled)

6. The system of claim 1, wherein each configuration connector is coupled to receive a configuration record from the configuration store, the configuration connector operable to receive the configuration record using at least one of a publish-subscribe pattern, a server-push pattern, a client-pull pattern, or manual entry by a user.

7. The system of claim 1, wherein the configuration processor is further operable to receive the updated configuration states either automatically from a designated subsystem or manually from a user, or both.

8. (canceled)

9. (canceled)

10. (canceled)

11. (canceled)

12. The system of claim 1, wherein the subsystem is a real-time data processing subsystem and the network-based services that may be enabled or disabled by the updated configuration state include real-time data processing services, including one or more of: network-based storage of current and previous data generated at the subsystem, network-based analysis of the data in real-time, network-based detection of occurrence of predefined events from the data, or network-based alerts of detected events to a notification system.

13. The system of claim 1, wherein the subsystem is a data visualization subsystem and the network-based services that may be enabled or disabled by the updated configuration state include visualization services, including one or more of: network-based display of current and previous data generated at the subsystem, network-based display of analysis of the data, network-based display of predefined events detected from the data, or network-based display of data processing cluster status.

14. The system of claim 1, wherein the subsystem is a cross-site integration subsystem and the network-based services that may be enabled or disabled by the updated configuration state include providing network-based access to data generated at the subsystem by one or more remotely located computing sites.

15. The system of claim 1, wherein the subsystem is an authentication and authorization subsystem and the network-based services that may be enabled or disabled by the updated configuration state include one or more of: a network-based federated identity provider, a network-based authorization system, or network-based access to one or more remotely located identification sources.

16. The system of claim 1, wherein the subsystem is a data segregation subsystem and the network-based services that may be enabled or disabled by the updated configuration state include one or more of: network-based storage of selected data types or network-based storage of data generated by selected data entities.

17. The system of claim 1, wherein the configuration state for at least one subsystem is customized according to one or more regulatory requirements, and wherein the one or more regulatory requirements include one or more privacy data regulatory requirements and the updated configuration state for at least one subsystem is set to enable or disable network-based storage of privacy data according to the one or more privacy data regulatory requirements.

18. (canceled)

19. A non-transitory computer-readable medium storing computer-readable instructions for causing a computing system to progressively enable or disable network-based services provided to a plurality of subsystems, the computer-readable instructions comprising instructions that cause the computing system to:
store a plurality of configuration records in a configuration store, wherein one or more configuration records correspond to a subsystem and include a configuration state for the subsystem, and wherein one or more configuration states specify which network-based services may be provided to the subsystem;
update the configuration records in the configuration store to include updated configuration states; and
distribute the updated configuration states to the subsystem for processing by a configuration connector in the subsystem, the configuration connector operable to identify one or more configuration actions that need to be performed to modify a configuration of the subsystem based on an updated configuration state for the subsystem;
wherein the subsystem is provided with network-based services as specified by an updated configuration state for the subsystem and wherein the configuration of the subsystem is modified to support the network-based services as specified by the updated configuration state for the subsystem.

20. (canceled)

21. (canceled)

22. (canceled)

23. (canceled)

24. The computer-readable medium of claim 19, wherein the computer readable instructions further cause the computing system to couple each configuration connector to receive a configuration record from the configuration store, the configuration connector operable by the computing system to receive the configuration record using one of a publish-subscribe pattern, a server-push pattern, a client-pull pattern, or manual entry by a user.

25. The computer-readable medium of claim 19, wherein the configuration processor is further operable by the computing system to receive the updated configuration states either automatically from a designated subsystem or manually from a user, or both.

26. (canceled)

27. (canceled)

28. (canceled)

29. (canceled)

30. The computer-readable medium of claim 19, wherein the subsystem is a real-time data processing subsystem and the network-based services that may be enabled or disabled by the updated configuration state include real-time data processing services, including one or more of: network-based storage of current and previous data generated at the subsystem, network-based analysis of the data in real-time, network-based detection of occurrence of predefined events from the data, or network-based alerts of detected events to a notification system.

31. The computer-readable medium of claim 19, wherein the subsystem is a data visualization subsystem and the network-based services that may be enabled or disabled by the updated configuration state include visualization services, including one or more of: network-based display of current and previous data generated at the subsystem, network-based display of analysis of the data, network-based display of predefined events detected from the data, or network-based display of data processing cluster status.

32. The computer-readable medium of claim 19, wherein the subsystem is a cross-site integration subsystem and the network-based services that may be enabled or disabled by the updated configuration state include providing network-based access to data generated at the subsystem by one or more remotely located computing sites.

33. The computer-readable medium of claim 19, wherein the subsystem is an authentication and authorization subsystem and the network-based services that may be enabled or disabled by the updated configuration state include one or more of: a network-based federated identity provider, a network-based authorization system, or network-based access to one or more remotely located identification sources.

34. The computer-readable medium of claim 19, wherein the subsystem is a data segregation subsystem and the network-based services that may be enabled or disabled by the updated configuration state include one or more of: network-based storage of selected data types or network-based storage of data generated by selected data entities.

35. The computer-readable medium of claim 19, wherein the configuration state for at least one subsystem is customized according to one or more regulatory requirements, and wherein the one or more regulatory requirements include one or more privacy data regulatory requirements and the updated configuration state for at least one subsystem is set to enable or disable network-based storage of privacy data according to the one or more privacy data regulatory requirements.

36. (canceled)

37. A method of progressively enabling or disabling network-based services provided to a plurality of subsystems, comprising:
storing a plurality of configuration records in a configuration store, wherein one or more configuration records correspond to a subsystem and include a configuration state for the subsystem, and wherein one or more configuration states specify which network-based services may be provided to the subsystem;
updating the configuration records in the configuration store to include updated configuration states; and
distributing the updated configuration states to the subsystem for processing by a configuration connector in the subsystem, the configuration connector operable to identify one or more configuration actions that need to be performed to modify a configuration of the subsystem based on an updated configuration state for the subsystem;
wherein the subsystem is provided with network-based services as specified by an updated configuration state for the subsystem and wherein the configuration of the subsystem is modified to support the network-based services as specified by the updated configuration state for the subsystem.
